(19) United States
(12) Patent Application Publication
(10) Pub. No.: US 2009/0050026 A1
(43) Pub. Date: Feb. 26, 2009

(54) TREATMENT OF CONCRETE STRUCTURES TO PROTECT THE CONCRETE AND THE REINFORCING RODS AGAINST THE EFFECTS OF ATMOSPHERIC AGENTS

(76) Inventor: Cesare Melegari, Noceto (IT)

Correspondence Address: YOUNG & THOMPSON, 209 Madison Street, Suite 500, ALEXANDRIA, VA, 22314, US

(21) Appl. No.: 12/197,326

(22) Filed: Aug. 25, 2008

(30) Foreign Application Priority Data
Aug. 24, 2007 (IT) PC2007A000041

(51) Int. Cl. C04B 40/00

(52) U.S. Cl. 106/823; 106/819

(57) ABSTRACT

Treatment of concrete structures designed to protect the concrete and prevent corrosion of the reinforcing rods by external agents, which includes filling of the micropores and cracks with a waterproofing material consisting of a substance designed to fill said pores and cracks, thus preventing the passage of external agents.

The treatment includes the following stages:
the structures are placed in a chamber which can be sealed;
a vacuum is created in said chamber;
the structures are stored under vacuum for a pre-determined time;
a filler designed to fill the pores and cracks in said structures is introduced into said chamber;
pressure is applied for a pre-determined time.

The material of the obtained structure, is highly compact, with no pores or openings through which water can penetrate and damage the concrete in case of frost.

External agents cannot reach the reinforcement, which is thus perfectly protected.

This invention provides a treatment for concrete structures which is designed to prevent corrosion of the reinforcing rods by atmospheric agents and to protect the concrete, especially where the structures are located in an aggressive environment.

More particularly, the invention relates to a treatment which involves filling the pores in concrete with a filling material able to prevent atmospheric agents, especially moisture and salt water, from impregnating the concrete and reaching the reinforcing rods which otherwise, with time, would suffer irreparable damage.

The invention also relates to structures to which said treatment has been applied.

Concrete is a material which always, by nature, has a certain degree of porosity, which may be high. The extent of said porosity depends on numerous factors such as the type of aggregate, the quantity of cement and water used in its composition, the extent and method of vibration, etc. Moreover, once installed, concrete structures are subject to cracking, which produces a series of very small fissures that extend to near the neutral axis.

Through these pores and cracks, water and atmospheric agents slowly penetrate into the material, and with time not only cause disintegration of the layers of concrete in the event of frost, but also reach the steel reinforcement, which is thus exposed to the risk of rust and corrosion;

Especially in the case of structures designed to be installed in aggressive environments, such as piles partly immersed in sea water, structures exposed to saline environments such as those on the sea shore, or road and motorway structures, on which a considerable quantity of salt is spread in winter, which then dissolves in rainwater and is conveyed by it into the pores in the concrete, serious problems can arise with the durability and safety of the structure.

With a view to limiting this problem, the structures are currently modified by increasing the thickness of the rod cover to protect the reinforcement, suitably adjusting the choice of aggregate and the quantity of cement and water used in the mixture, and seeking to vibrate the concrete as well as possible when it is cast in moulds or forms, to make it more compact and less porous.

However, these solutions are only partly effective; they improve the quality of the concrete and reduce the extent of the problem, but do not wholly eliminate it.

It would be useful to have means which allow concrete structures not affected by these problems to be obtained, so that construction elements can be made and installed even in aggressive environments in complete safety and without the risk that over the years, the steel reinforcement will be exposed to the action of external agents.

This problem has now been solved by the present invention, which offers a treatment for concrete structures designed to protect the concrete and prevent corrosion of the reinforcing rods by atmospheric agents; said treatment involves placing the structure in an autoclave, creating a vacuum therein so that the air in the pores is removed, and then introducing into the autoclave, preferably under pressure, a product able to fill said pores and prevent water and atmospheric agents from impregnating the concrete with time and reaching the reinforcement.

This invention will now be described in detain, by way of example but not of limitation, by reference to the annexed figures wherein:

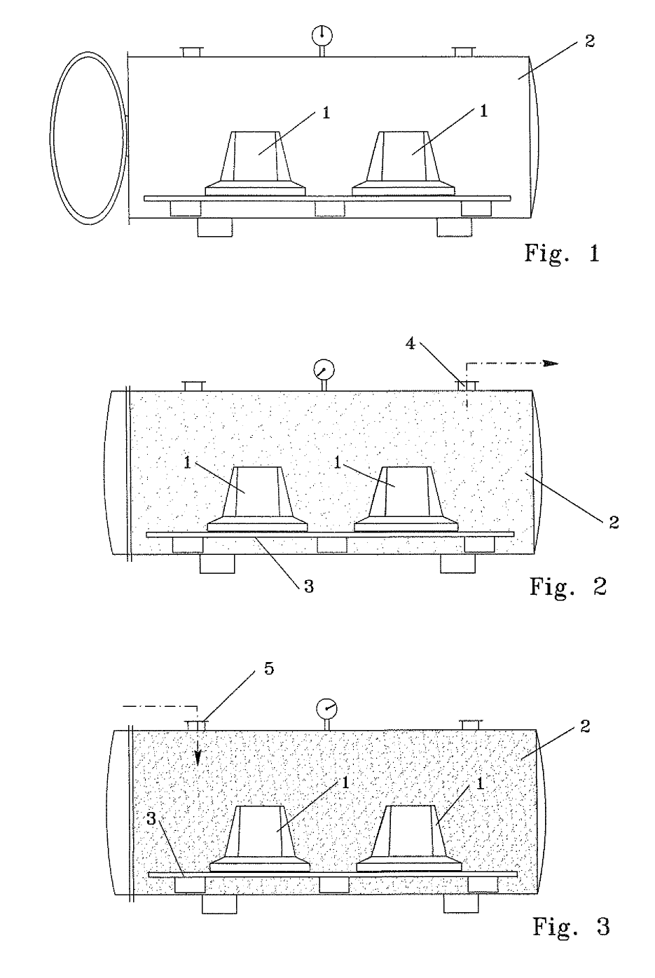

FIGS. 1 to 3 schematically illustrate the stages of treatment according to the invention.

As shown in the annexed figures, once structures 1 have been cured, the treatment according to the invention involves placing them in an autoclave or the like 2, and arranging them, for example, on a supporting grid 3, which leaves their entire surface exposed.

The autoclave is then closed, a vacuum is created in it with equipment of known type, and the air is sucked through an outlet aperture 4 (FIG. 2).

When a vacuum has been created in the autoclave, the structures are maintained under those conditions for a few minutes to be sure that the air is sucked out of even the innermost pores.

Said period of time varies according to the type of concrete and the size of the structure. 3-5 minutes is generally sufficient for small structures, whereas the period could be 10 minutes or more for larger structures.

At the end of this first stage a filler, consisting of a material resistant to aggressive agents and able to fill the pores in the concrete, is introduced into autoclave 2, through an inlet aperture 5.

This material preferably consists of a silicate resin such as sodium silicate, but different materials, such as acrylic resins or the like, could also be used.

Said material is introduced into the autoclave until it fills the autoclave or at least completely covers structures 1, after which the pressure in the autoclave (FIG. 3) is increased, using equipment of known type, until it reaches a value of approx. 10 bars.

The structures are maintained under these conditions for about 30 minutes, while the filler completely fills the pores in the concrete.

At the end of that time the pressure is released, and the autoclave can be opened to remove the structures ready for use, possibly after washing.

The concrete of the structure is now a highly compact material, with no pores or openings through which water can penetrate and damage the concrete in case of frost, and external agents cannot reach the reinforcement, which is thus perfectly protected.

As stated, different types of materials could be used as fillers, although silicate resins or acrylic resins are preferred because they are already used, for example, to reclaim or waterproof soil using the jet-grouting technique, and have therefore been extensively tested under these conditions and given reliable, lasting results.

1. Treatment of concrete structures designed to protect the concrete and prevent corrosion of the reinforcing rods by external agents, characterised in that it includes filling of the micropores and cracks with a material consisting of a substance designed to fill said pores and cracks, thus preventing the passage of external agents.

2. Treatment of concrete structures as claimed in claim 1, wherein said filler is a waterproofing material.

3. Treatment of concrete structures as claimed in claim 1, which includes the following stages:
the structures are placed in a chamber which can be sealed;
a vacuum is created in said chamber;
the structures are stored under vacuum for a pre-determined time;
a filler designed to fill the pores and cracks in said structures is introduced into said chamber;
pressure is applied for a pre-determined time.

4. Treatment of concrete products as claimed in claim 3, wherein in that said filler is a silicate resin.

5. Treatment of concrete structures as claimed in claim 4, wherein said filler is sodium silicate.

6. Treatment of concrete structures as claimed in claim 3, wherein said filler is an acrylic resin.

7. Treatment of concrete structures as claimed in claim 3, wherein that said structures are maintained under vacuum for a period of between 3 and 10 minutes and subsequently kept immersed in said filler for between 5 and 15 minutes at a pressure of between 5 and 15 bars.

8. Treatment of concrete structures as claimed in claim 2, which includes the following stages:
the structures are placed in a chamber which can be sealed;
a vacuum is created in said chamber;
the structures are stored under vacuum for a pre-determined time;
a filler designed to fill the pores and cracks in said structures is introduced into said chamber;
pressure is applied for a pre-determined time.

9. Treatment of concrete structures as claimed in claim 4, wherein that said structures are maintained under vacuum for a period of between 3 and 10 minutes and subsequently kept immersed in said filler for between 5 and 15 minutes at a pressure of between 5 and 15 bars.

10. Treatment of concrete structures as claimed in claim 5, wherein that said structures are maintained under vacuum for a period of between 3 and 10 minutes and subsequently kept immersed in said filler for between 5 and 15 minutes at a pressure of between 5 and 15 bars.

11. Treatment of concrete structures as claimed in claim 6, wherein that said structures are maintained under vacuum for a period of between 3 and 10 minutes and subsequently kept immersed in said filler for between 5 and 15 minutes at a pressure of between 5 and 15 bars.

12. Treatment of concrete products as claimed in claim 8, wherein in that said filler is a silicate resin.

13. Treatment of concrete structures as claimed in claim 12, wherein said filler is sodium silicate.

14. Treatment of concrete structures as claimed in claim 8, wherein said filler is an acrylic resin.

15. Treatment of concrete structures as claimed in claim 8, wherein that said structures are maintained under vacuum for a period of between 3 and 10 minutes and subsequently kept immersed in said filler for between 5 and 15 minutes at a pressure of between 5 and 15 bars.
